(19) United States
(12) Patent Application Publication
(10) Pub. No.: US 2020/0281152 A1
(43) Pub. Date: Sep. 10, 2020

(54) LIVESTOCK STALL SYSTEM

(71) Applicant: MAYEKAWA MFG. CO., LTD., Koto-ku, Tokyo (JP)

(72) Inventors: Kiyoshi HIGUCHI, Tokyo (JP); Hidehiro KITAYAMA, Tokyo (JP); Kazutoshi ITO, Tokyo (JP); Takayuki OKADA, Tokyo (US)

(73) Assignee: MAYEKAWA MFG. CO., LTD., Koto-ku, Tokyo (JP)

(21) Appl. No.: 16/756,505

(22) PCT Filed: Oct. 31, 2018
(86) PCT No.: PCT/JP2018/040585

§ 371 Date: Apr. 16, 2020

(30) Foreign Application Priority Data
Nov. 1, 2017 (JP) PCT/JP2017/039586

(51) Int. Cl. A01K 1/00; F24D 3/14; F24D 3/18

(52) U.S. Cl. CPC A01K 1/0076; A01K 1/0011; F24D 3/18; F24D 3/145; A01K 1/0082

(57) ABSTRACT

A livestock stall system which can take measures against the cold of winter and against the heat of summer while preventing worsening of the condition of the litter (the flooring) and maintaining a favorable environment inside the livestock stall. This livestock stall system includes a livestock stall in which livestock is raised, and a second pipe which is arranged so as to pass beneath the floor of the livestock stall and which adjusts the temperature of the floor surface of the livestock stall by circulating a medium through the inside of the pipe.

### TECHNICAL FIELD

The present invention relates to a livestock stall system.

### BACKGROUND ART

A livestock stall system is required to maintain a favorable livestock raising environment. For example, a poultry farming system needs to take measures against the cold of winter and the heat of summer to maintain a favorable chicken raising environment. In particular, since newborn chicks are fragile, the newborn chicks need to be kept in a high-temperature close to body temperature and calm environment.

Examples of a method of heating the livestock stall can include hot air heating and brooder heating. The hot air heating is undesirable because irradiating the chicks with wind will take the body temperature away from the chicks. In addition, the brooder heating is undesirable because it uses fossil fuels and generates carbon dioxide, which leads to global environmental degradation. In addition, in a gas brooder method used for heating, since local heating is applied, the temperature of the litter (bedding) becomes uneven, and the condition of the litter (bedding) deteriorates. In addition, exhaust gas, soot, and the like also have an effect on ecology, and it is difficult to make the whole stall a suitable environment.

In addition, examples of a method of cooling the livestock stall can include, for example, a method of increasing or decreasing the amount of ventilation with a ventilation fan attached to the livestock stall according to the outside air temperature or the temperature inside the livestock stall, a method of spraying mist in the stall and cooling the stall by heat of vaporization, a method of directly sprinkling water on the livestock when the temperature is extremely high, or the like. In the case of spraying the mist, when the humidity is high, it is not possible to use the heat of vaporization and it is difficult to appropriately cool the stall. Further, in the case of directly sprinkling the water on the livestock, since the litter (bedding) gets wet, the condition of the litter (bedding) deteriorates.

On the other hand, Patent Literature 1 below discloses breeding chicks by floor heating. The floor heating is a method of burying a pipe under the floor of the livestock stall and circulating a heating medium inside the pipe to warm a floor surface. According to such floor heating, since the chicks are not irradiated with the wind and it is not necessary to further use the fossil fuels, the chickens can be suitably bred. The floor heating is favorable for such heating, but in a case of lowering the temperature in the livestock stall, there is an only method of naturally cooling the livestock stall and there is a poor response to an ever-changing external environment. In addition, the floor heating can heat the entire floor, but in the case of lowering the temperature, there is an only method of naturally cooling the floor and it is difficult to adjust to a suitable temperature.

### CITATION LIST

### Patent Literatures

Patent Literature 1: WO2003/007928

### SUMMARY OF INVENTION

### Technical Problem

From the above, in the livestock stall system, it is necessary to take measures against the cold of winter and the heat of summer while maintaining the inside of the livestock stall in a favorable environment and preventing the deterioration of the condition of the litter (bedding). Further, since the environment inside the livestock stall also greatly fluctuates when a temperature difference during the day is large, the impact on the livestock is large and there is a need for a comfortable livestock stall not only in winter and summer but also throughout the year.

The present invention has been invented to solve the above problems, and is to provide a livestock stall system that can take measures against cold of winter and heat of summer while maintaining the inside of the livestock stall in a favorable environment and preventing the deterioration of the condition of the litter (bedding).

### Solution to Problem

A livestock stall system according to the present invention includes a livestock stall in which livestock is bred, and a pipe that is arranged so as to pass under the livestock stall and adjusts a temperature of a floor surface of the livestock stall by a medium that circulates the inside thereof.

### Advantageous Effects of Invention

According to the livestock stall system configured as described above, the temperature of the floor surface of the livestock stall is adjusted by the medium that circulates through the inside of the pipe. For this reason, floor heating and floor cooling can be appropriately adopted. For this reason, it is possible to take measures against the cold of winter and the heat of summer, while maintaining the livestock stall in a favorable environment and preventing the deterioration of the litter (bedding). Further, it is possible to provide a comfortable livestock stall not only in winter and summer, but also throughout the year.

### BRIEF DESCRIPTION OF DRAWINGS

FIG. 1 is a systematic diagram showing a poultry farming system according to a first embodiment.

FIG. 2 is a systematic diagram showing a heat pump of the poultry farming system according to the first embodiment.

FIG. 3 is a systematic diagram showing a portion of a heating unit of the poultry farming system according to the first embodiment.

FIG. 4 is a systematic diagram showing a poultry farming system according to a second embodiment and is a diagram showing a state when floor heating is performed.

FIG. 5 is the systematic diagram showing the poultry farming system according to the second embodiment and is a diagram showing a state when floor cooling is performed.

FIG. 6 is the systematic diagram showing the poultry farming system according to the second embodiment and is a diagram showing a state in which a first medium and a second medium are mixed to bring a floor surface of a poultry house to a predetermined temperature.

FIG. 7 is a systematic diagram showing a portion of a heating unit of a poultry farming system according to Modified Example 1.

FIG. 8 is a schematic systematic diagram showing a poultry farming system according to Modified Example 2.

FIG. 9 is a schematic systematic diagram showing a portion of a poultry farming system according to Modified Example 3.

### DESCRIPTION OF EMBODIMENTS

### First Embodiment

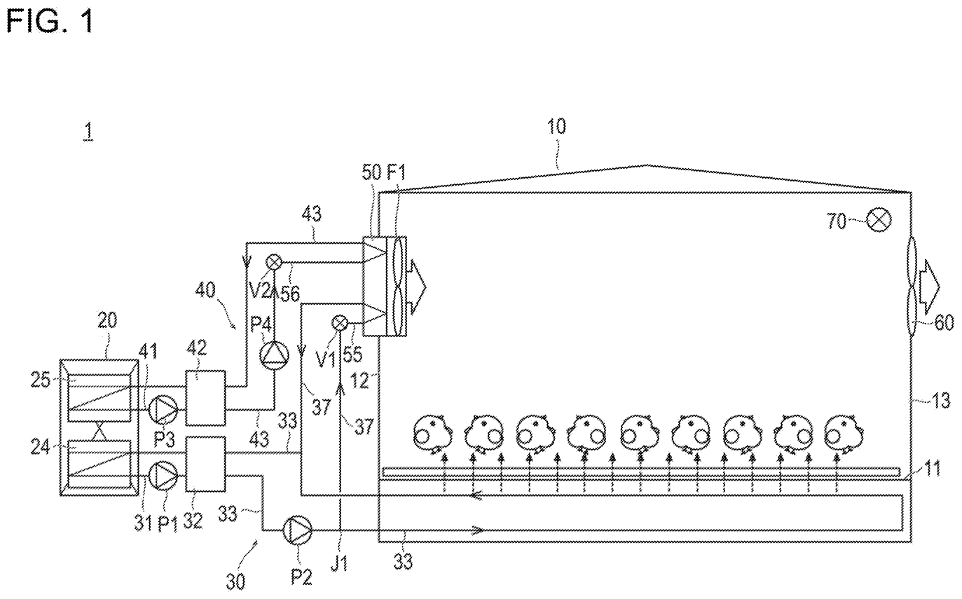

A first embodiment of the present invention will be described with reference to FIGS. 1 to 3. Note that in the description of the drawings, the same elements will be denoted by the same reference symbols, without redundant description. The dimensional ratios in the drawings are exaggerated for the sake of explanation and may differ from the actual ratios.

In the present embodiment, as a livestock stall system, a poultry farming system for breeding chickens will be described as an example.

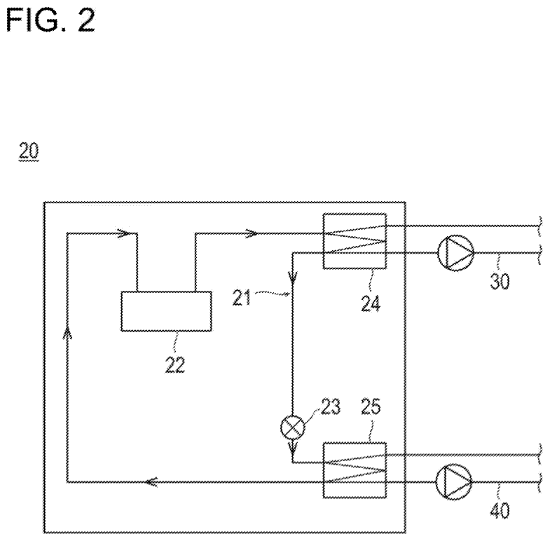

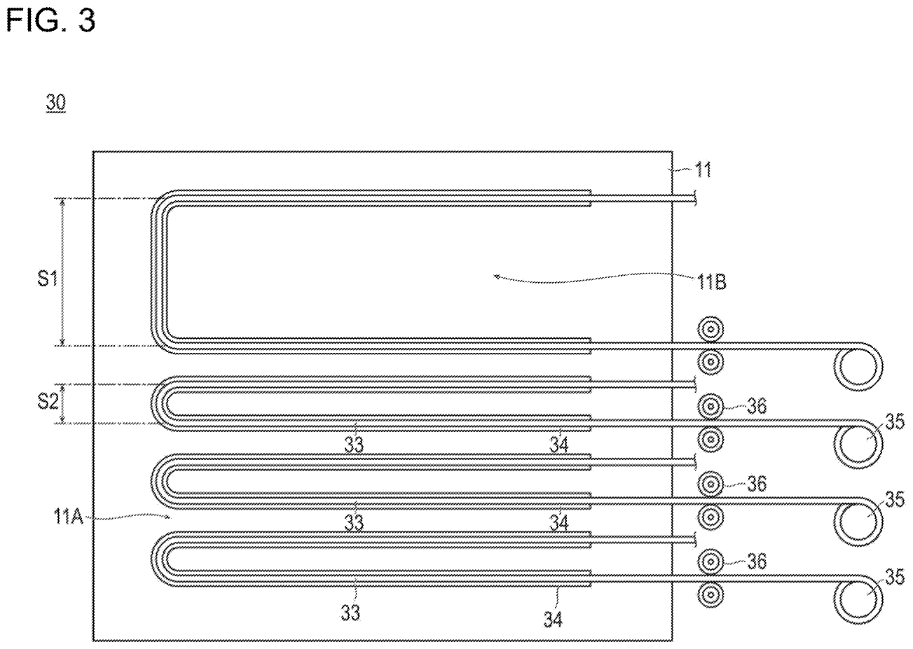

FIG. 1 is a systematic diagram showing a poultry farming system (livestock stall system) 1 according to a first embodiment. FIG. 2 is a systematic diagram showing a heat pump 20 of the poultry farming system 1 according to the first embodiment. FIG. 3 is a systematic diagram showing a portion of the heating unit 30 of the poultry farming system 1 according to the first embodiment and is a diagram when viewed from above. In FIG. 3, the heating unit 30 is shown by a solid line for easy understanding.

As shown in FIG. 1, the poultry farming system 1 includes a poultry house 10 in which chickens are bred, a heat pump 20 capable of simultaneously taking out cold and hot heat, a heating unit 30 for heating the inside of the poultry house 10, a cooling unit 40 for cooling the inside of the poultry house 10, an adjusting unit 50 for adjusting temperature and humidity in the poultry house 10, an exhaust fan 60 for exhausting air in the poultry house 10, and a sterilizer 70 for sterilizing the inside of the poultry house 10.

As shown in FIG. 1, the poultry house 10 includes a floor surface 11, a left side wall 12, and a right side wall 13. On the floor surface 11, for example, a litter (bedding) is arranged, on which chicks or chickens are bred. Below a floor of the floor surface 11, a second pipe 33 described later is arranged.

The adjusting unit 50 is attached to the left side wall 12. In addition, the exhaust fan 60 is attached to the right side wall 13.

The heat pump 20 is configured to be able to simultaneously take out cold and hot heat. In addition, the heat pump 20, together with a heating tank 32 and a cooling tank 42 described later, is also configured to be able to take out only hot or cold heat. Since the heat pump 20 is an electric type, the heat pump 20 does not use fire and thus there is no need to worry about fire. Hereinafter, a configuration of the heat pump 20 will be described in detail with reference to FIG. 2.

As shown in FIG. 2, the heat pump 20 includes a refrigerant flow passage 21 through which a refrigerant circulates, a compressor 22 for compressing the refrigerant, an expansion valve 23 for expanding the refrigerant, a hot heat exchanger 24 for supplying hot heat to a first medium (corresponding to a medium) circulating in the heating unit 30, and a cold heat exchanger 25 for supplying cold heat to a second medium circulating in the cooling unit 40. Note that the refrigerant circulating in the refrigerant flow passage 21 is not particularly limited, but for example, carbon dioxide can be used.

The compressor 22 is provided in the refrigerant flow passage 21. The compressor 22 is not particularly limited, but for example, a CO₂ compressor can be used. By being compressed when the refrigerant passes through the compressor 22, the compressor 22 increases a temperature of the refrigerant.

The expansion valve 23 is provided in the refrigerant flow passage 21. By being expanded when the refrigerant passes through the expansion valve 23, the expansion valve 23 lowers the temperature of the refrigerant.

The hot heat exchanger 24 is arranged between the compressor 22 and the expansion valve 23. The hot heat exchanger 24 heats the first medium circulating in the heating unit 30 by a high-temperature refrigerant circulating from the compressor 22 toward the expansion valve 23. Here, the temperature of the first medium heated by the hot heat exchanger 24 can be, for example, 65° C. or 90° C.

The cold heat exchanger 25 is arranged between the expansion valve 23 and the compressor 22. The cold heat exchanger 25 cools the second medium circulating in the cooling unit 40 by a low-temperature refrigerant circulating from the expansion valve 23 toward the compressor 22.

According to the heat pump 20 configured as described above, the hot heat exchanger 24 heats the first medium circulating in the heating unit 30, and the cold heat exchanger 25 cools the second medium circulating in the cooling unit 40. Therefore, the heat pump 20 is in a state where hot and cold heat can be simultaneously taken out.

Returning to FIG. 1, the heating unit 30 heats the inside of the poultry house 10 by the first medium heated by the hot heat taken out of the heat pump 20 circulating through the inside of the heat pump 20. As shown in FIGS. 1 and 3, the heating unit 30 includes a first pipe 31 for receiving the hot heat from the hot heat exchanger 24, a heating tank 32 in which the first medium that has received the hot heat from the hot heat exchanger 24 is stored, a second pipe (corresponding to a pipe) 33 arranged below the floor of the poultry house 10, a positioning portion 34 for positioning and fixing the second pipe 33, a winding portion 35 capable of winding the second pipe 33, a cleaning portion 36 for cleaning the second pipe 33, and a third pipe 37 connected to the adjusting unit 50 through a first piping 55.

The circulation of the first medium in the first pipe 31 is performed by a first heating pump P1. The circulation of the first medium in the second pipe 33 is performed by a second heating pump P2. In addition, the first medium circulating in the first pipe 31, the second pipe 33, and the third pipe 37 is not particularly limited, but is, for example, water.

The first medium that has received the hot heat from the hot heat exchanger 24 circulates inside the first pipe 31. Then, the first medium that has received the hot heat from the hot heat exchanger 24 is stored in the heating tank 32. By storing the first medium in the heating tank 32 in this manner, the first medium can be transferred to the second pipe 33 at a desired timing.

The second pipe 33 is branched from the third pipe 37 at a branch portion J1. The third pipe 37 is connected to the first piping 55 at a switching valve V1. The switching valve V1 switches on/off of the supply of the first medium passing through the third pipe 37 to the adjusting unit 50.

It is preferable that outer circumferences of the first pipe 31, the second pipe 33, and the third pipe 37 have anticorrosion properties.

As shown in FIG. 3, the positioning portion 34 can position the second pipe 33 such that a position of the second pipe 33 is variable. The positioning portion 34 includes a concave portion (not shown) in which the second pipe 33 is mounted. In the present embodiment, the positioning portion 34 positions the second pipe 33 so that intervals S1 and S2 between adjacent second pipes 33 are different from each other, as shown in FIG. 3. The positioning portion 34 positions the second pipe 33 so that a distance from the floor surface 11 is constant. The positioning portion 34 also serves as a heat insulating sheet. According to such a configuration, it is possible to save energy of hot heat required for heating the floor surface 11.

By positioning and fixing the second pipe 33 by the positioning portion 34 in this manner, as shown in FIG. 3, there are places where the second pipe 33 is arranged and places where the second pipe 33 is not arranged. As a result, a warm place 11A and a cool place 11B can be provided on the floor surface 11 of the poultry house 10. Therefore, the chicken can move by selecting the warm place 11A or the cool place 11B by itself.

The winding portion 35 can wind the second pipe 33. The winding portion 35 is a storage drum, and in FIG. 3, the winding portion 35 can send out the second pipe 33 from the winding portion 35 by rotating counterclockwise, and collect the second pipe 33 by rotating clockwise. Since the winding portion 35 is provided in this manner, the collection and the laying of the second pipe 33 are easily performed when it is desired to change a poultry farming place.

The cleaning portion 36 is provided so as to be adjacent to the winding portion 35. The cleaning portion 36 is arranged so as to be in contact with the second pipe 33, and removes and cleans dust attached to the surface of the second pipe 33 when the second pipe 33 is wound around the winding portion 35.

The cooling unit 40 cools the inside of the poultry house 10 as shown in FIG. 1. The cooling unit 40 includes a fourth pipe 41 for receiving the cold heat from the cold heat exchanger 25, a cooling tank 42 in which the second medium that has received the cold heat from the cold heat exchanger 25 is stored, and a fifth pipe 43 connected to the adjusting unit 50 through the second piping 56.

The circulation of the second medium in the fourth pipe 41 is performed by a first cooling pump P3 as shown in FIG. 1. The circulation of the second medium in the fifth pipe 43 is performed by a second cooling pump P4. The second medium circulating in the fourth pipe 41 and the fifth pipe 43 is not particularly limited, but is, for example, water. The temperature of the second medium circulating in the fourth pipe 41 and the fifth pipe 43 is, for example, 7 to 10° C.

The second medium that has received the cold heat from the cold heat exchanger 25 circulates inside the fourth pipe 41. Then, the second medium that has received the cold heat from the cold heat exchanger 25 is stored in the cooling tank 42. By storing the second medium in the cooling tank 42 in this manner, the second medium can be transferred to the fifth pipe 43 at a desired timing.

The fifth pipe 43 is connected to a second piping 56 at a switching valve V2. The switching valve V2 switches on/off of the supply of the second medium passing through the fifth pipe 43 to the adjusting unit 50.

It is preferable that outer circumferences of the fourth pipe 41 and the fifth pipe 43 have anticorrosion properties.

Since the heating unit 30 and the cooling unit 40 are provided in this manner, only the hot heat can be taken out by turning on the second heating pump P2 and turning off the second cooling pump P4. On the other hand, only the cold heat can be taken out by turning off the second heating pump P2 and turning on the second cooling pump P4.

The adjusting unit 50 adjusts the temperature and humidity in the poultry house 10. The adjusting unit 50 is arranged in the first piping 55 and the second piping 56. A fan F1 is arranged next to the adjusting unit 50.

In order for the adjusting unit 50 to heat the inside of the poultry house 10, the switching valve V1 turns on the supply of the first medium passing through the third pipe 37 to the adjusting unit 50, and the switching valve V2 turns off the supply of the second medium passing through the fifth pipe 43 of the cooling unit 40 to the adjusting unit 50.

In addition, in order for the adjusting unit 50 to cool the inside of the poultry house 10, the switching valve V1 turns off the supply of the first medium passing through the third pipe 37 to the adjusting unit 50, and the switching valve V2 turns on the supply of the second medium passing through the fifth pipe 43 of the cooling unit 40 to the adjusting unit 50.

In order for the adjusting unit 50 to dehumidify the inside of the poultry house 10, the switching valve V1 turns off the supply of the first medium passing through the third pipe 37 to the adjusting unit 50, and the switching valve V2 turns on the supply of the second medium passing through the fifth pipe 43 of the cooling unit 40 to the adjusting unit 50. Dehumidification is performed by cooling air in the vicinity of the adjusting unit 50 by the second medium, removing moisture by changing the moisture into water droplets and condensing the moisture, and discharging dried air.

In addition, when the adjusting unit 50 turns off the dehumidification function, the switching valve V1 turns off the supply of the first medium passing through the third pipe 37 to the adjusting unit 50, and the switching valve V2 turns on the supply of the second medium passing through the fifth pipe 43 of the cooling unit 40 to the adjusting unit 50.

The sterilizer 70 is provided in the poultry house 10 and sterilizes the inside of the poultry house 10. As the sterilizer 70, for example, an excimer lamp can be used. By using the excimer lamp as the sterilizer 70 in this way, ozone and radicals with good diffusibility can be generated, the sterilization can be made, virus growth can be suppressed, and a deodorant effect on smell and ammonia can be increased. Therefore, it is possible to safely promote the growth of chicks by realizing a comfortable environment. Further, as the sterilizer, a discharge type ozonizer may be used.

Next, a method of breeding chickens by the poultry farming system 1 according to the first embodiment will be described.

For example, in winter, it is preferable to set the inside of the poultry house 10 to a high temperature environment so as to be able to cope with a sudden drop in the outside air temperature.

In winter, only the hot heat can be taken out by turning on the second heating pump P2 and turning off the second cooling pump P4.

At this time, the first medium that has received the hot heat from the hot heat exchanger 24 circulates through the inside of the first pipe 31, and the first medium that has received the hot heat is stored in the heating tank 32. Then, by turning on the second heating pump P2, the second pipe 33 can warm the inside of the poultry house 10 from under the floor of the poultry house 10. Here, the positioning portion 34 positions the second pipe 33 so that the intervals S1 and S2 between the adjacent second pipes 33 are different from each other. For this reason, as shown in FIG. 3, a warm place 11A and a cool place 11B can be provided on the floor surface 11 of the poultry house 10. Therefore, the chicken can move by selecting the warm place 11A or the cool place 11B by itself.

In addition, by turning on the supply of the first medium passing through the third pipe 37 to the adjusting unit 50 at the switching valve V1, the adjusting unit 50 can warm the inside of the poultry house 10.

On the other hand, in summer, it is preferable to set the inside of the poultry house 10 to a low temperature environment so as to be able to cope with a sudden rise in the outside air temperature.

In summer, only the cold heat can be taken out by turning off the second heating pump P2 and turning on the second cooling pump P4.

Thus, the second medium is circulated through the fifth pipe 43 of the cooling unit 40. Then, the switching valve V1 turns off the supply of the first medium passing through the third pipe 37 to the adjusting unit 50, and the switching valve V2 turns on the supply of the second medium passing through the fifth pipe 43 of the cooling unit 40 to the adjusting unit 50. As a result, the inside of the poultry house 10 can be cooled by the adjusting unit 50.

Further, in the middle period such as spring or autumn, the above-described summer mode and winter mode are appropriately switched and used according to the temperature of the day. In addition, in the case of a humid climate, such as during a rainy season, it is preferable to turn on the dehumidification function in the adjusting unit 50 to dehumidify the poultry house 10.

Hereinafter, for example, a preferred method of properly using 65° C. and 90° C., which is the temperature of the first medium heated by the hot heat exchanger 24, will be described.

For example, in a general poultry house, after entering the poultry house in the state of a chick, the chicken is shipped as an adult chicken after about 52 days. Thereafter, cleaning, sterilization, and drying are performed in about 14 days, and breeding is thus carried out in one cycle fora total of about 66 days. Therefore, about 5.5 rotations per year are carried out. Here, the so-called empty house period in which cleaning, sterilization, and drying are performed is equivalent to 77 days a year.

Here, when the first medium is used for heating the poultry house 10, it is preferable to use, for example, 65° C. as the temperature of the first medium. On the other hand, when the first medium is used for drying the poultry house 10 during the empty house period, it is preferable to use, for example, 90° C. as the temperature of the first medium. As described above, in the empty house period, by increasing the temperature of the first medium, a drying period can be shortened, and the empty house period can be shortened, for example, by two days. Therefore, it is possible to improve the productivity of the poultry farming system 1.

As described above, the poultry farming system 1 according to the first embodiment includes the poultry house 10 in which the chickens are bred, and the second pipe 33 that is arranged to pass under the floor of the poultry house 10 and adjusts the temperature of the floor surface 11 of the poultry house 10 by the first medium circulating through the inside of the second pipe 33. According to the poultry farming system 1 configured as described above, the temperature of the floor surface 11 of the poultry house 10 is adjusted by the first medium circulating through the inside of the second pipe 33. For this reason, it is possible to take measures against cold of winter and measures against heat of summer while maintaining the inside of the poultry house 10 in a suitable environment and preventing deterioration of the condition of the litter (bedding). Further, even when a temperature difference during the day is large, it is possible to suitably adjust the temperature in the poultry house 10. Therefore, it is possible to provide a comfortable poultry house 10 not only in winter and summer but also throughout the year.

In addition, the second pipe 33 is arranged so that a temperature difference occurs on the floor surface 11. As a result, a warm place 11A and a cool place 11B can be provided on the floor surface 11 of the poultry house 10. Therefore, it is possible to provide the poultry farming system 1 in which the chickens can move to the warm place 11A or the cool place 11B by themselves.

In addition, the poultry farming system 1 further includes the positioning portion 34 for positioning the second pipe 33 so that the position of the second pipe 33 is variable. According to the poultry farming system 1 configured as described above, the second pipe 33 can be positioned and fixed so that a place where the second pipe 33 is arranged and a place where the second pipe 33 is not arranged are formed under the floor of the poultry house 10. As a result, the warm place 11A and the cool place 11B can be provided on the floor surface 11 of the poultry house 10.

In addition, the second pipe 33 is arranged such that the intervals S1 and S2 between the adjacent second pipes 33 are different from each other. According to the poultry farming system 1 configured as described above, it is possible to reliably provide the warm place 11A and the cool place 11B on the floor surface 11 of the poultry house 10.

In addition, the poultry farming system 1 further includes the winding portion 35 capable of winding the second pipe 33. According to the poultry farming system 1 configured as described above, when it is desired to change a poultry farming place, the collection and the laying of the second pipe 33 are easily performed.

In addition, the poultry farming system 1 further includes the cleaning portion 36 for cleaning the second pipe 33 when the second pipe 33 is wound around the winding portion 35. According to the poultry farming system 1 configured as described above, the dust attached to the surface of the second pipe 33 is easily removed and cleaned.

### Second Embodiment

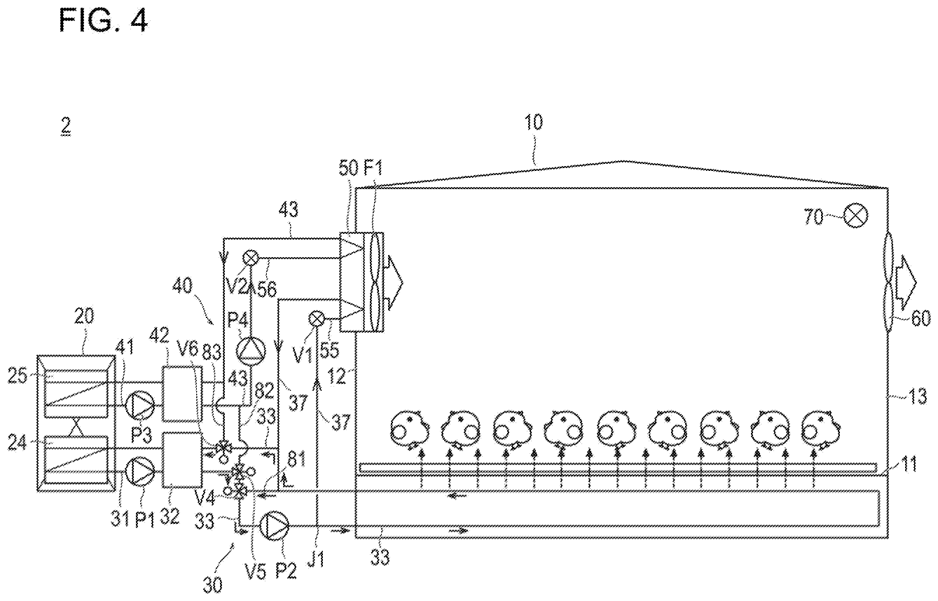

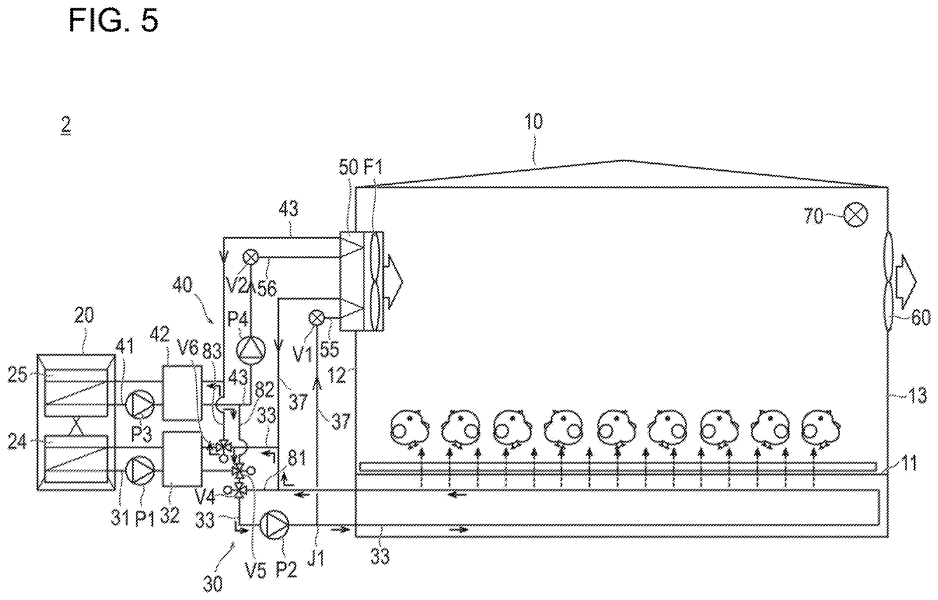

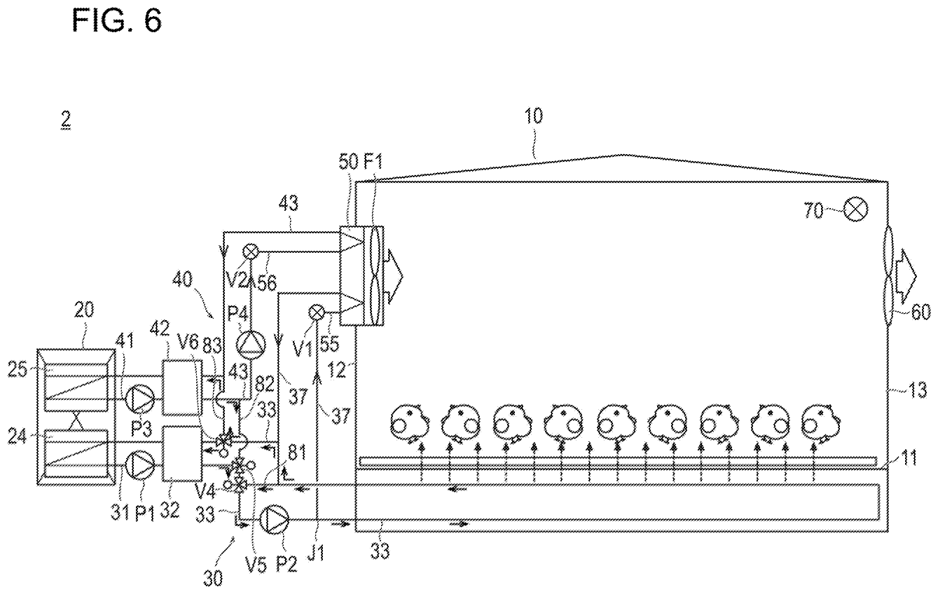

Next, a poultry farming system 2 according to a second embodiment will be described with reference to FIGS. 4 to 6. FIG. 4 is a systematic diagram showing a poultry farming system 2 according to a second embodiment and is a diagram showing a state when floor heating is performed. FIG. 5 is the systematic diagram showing the poultry farming system 2 according to the second embodiment and is a diagram showing a state when floor cooling is performed. FIG. 6 is the systematic diagram showing the poultry farming system 2 according to the second embodiment and is a diagram showing a state in which a first medium and a second medium are mixed to bring a floor surface 11 of a poultry house 10 to a predetermined temperature. A description of portions common to the first embodiment will be omitted, and portions having features only in the second embodiment will be described. Note that the same members as those in the first embodiment described above are denoted by the same reference numerals, and redundant description will be omitted. The poultry farming system 2 according to the second embodiment is different in that the first medium stored in the heating tank 32 and the second medium stored in the cooling tank 42 are configured to be mixed as compared with the poultry farming system 1 according to the first embodiment.

As shown in FIGS. 4 to 6, the poultry farming system 2 includes a poultry house 10 in which chickens are bred, a heat pump 20 capable of simultaneously taking out cold and hot heat, a heating unit 30 for heating the inside of the poultry house 10, a cooling unit 40 for cooling the inside of the poultry house 10, an adjusting unit 50 for adjusting the temperature and humidity in the poultry house 10, an exhaust fan 60 for exhausting air in the poultry house 10, a sterilizer 70 for sterilizing the inside of the poultry house 10, a first bypass 81 for circulating a first medium in a second pipe 33, and a second bypass 82 and a third bypass 83 connecting a second pipe 33 and a fifth pipe 43 to each other. Since the configurations of the poultry house 10, the heat pump 20, the heating unit 30, the cooling unit 40, the adjusting unit 50, the exhaust fan 60, and the sterilizer 70 are the same as the configurations of the poultry farming system 1 according to the above-described first embodiment, a description thereof will be omitted. That is, the poultry farming system 2 according to the second embodiment further includes the first bypass 81, the second bypass 82, and the third bypass 83 with respect to the poultry farming system 1 according to the first embodiment.

The first bypass 81 is provided to circulate the first medium in the second pipe 33, as shown in FIG. 4. A three-way valve V4 is arranged at a place where the first bypass 81 is connected to the second pipe 33 (a connection place on the left side in FIG. 4). The first medium circulated through the second pipe 33 returns to the second pipe 33 through the first bypass 81 and the three-way valve V4.

As shown in FIG. 5, when the second medium stored in the cooling tank 42 moves to the second pipe 33, the second medium passes through the second bypass 82. In addition, as shown in FIG. 5, when the second medium returns from the second pipe 33 to the cooling tank 42, the second medium passes through the third bypass 83. A three-way valve V5 is arranged at a place where the second bypass 82 is connected to the second pipe 33. A three-way valve V6 is arranged at a place where the third bypass 83 is connected to the second pipe 33.

Next, a method for breeding chickens by the poultry farming system 2 according to the second embodiment will be described.

For example, in winter, it is preferable to set the inside of the poultry house 10 to a high temperature environment so as to cope with a sudden drop in the outside air temperature.

In winter, as shown in FIG. 4, by adjusting the three-way valves V4, V5, and V6 while turning on the second heating pump P2 and turning off the second cooling pump P4, only the first medium is circulated through the second pipe 33. As a result, the floor surface 11 of the poultry house 10 is heated by floor heating.

On the other hand, in summer, it is preferable to set the inside of the poultry house 10 to a low temperature environment so as to cope with a sudden rise in the outside air temperature.

In summer, as shown in FIG. 5, by adjusting the three-way valves V4, V5, and V6 while turning off the second heating pump P2 and turning on the second cooling pump P4, only the second medium is circulated through the second pipe 33. As a result, the floor surface 11 of the poultry house 10 is cooled by floor cooling. At this time, the second medium stored in the cooling tank 42 circulates in the order of the fifth pipe 43, the second bypass 82, the three-way valve V5, the second pipe 33, the three-way valve V6, the third bypass 83, and the fifth pipe 43.

On the other hand, in the middle period such as spring or autumn, it is preferable to set the temperature of the floor surface 11 of the poultry house 10 to a predetermined temperature according to the temperature of the day.

In the middle period, as shown in FIG. 6, by adjusting the three-way valves V4, V5, and V6 while turning on the second heating pump P2 and turning on the second cooling pump P4, a mixed medium of the first medium and the second medium is circulated through the second pipe 33. As a result, the floor surface 11 of the poultry house 10 can be set to a predetermined desired temperature. Further, by adjusting the three-way valves V5 and V6, an amount of the second medium flowing into the second pipe 33 can be adjusted, and as a result, a temperature of the mixed medium can be adjusted.

As described above, the poultry farming system 2 according to the second embodiment further includes the heat pump 20 capable of simultaneously taking out cold and hot heat, and the floor surface 11 of the poultry house 10 is cooled by circulating the second medium cooled by the cold heat in the inside of the second pipe 33. According to the poultry farming system 2 configured as described above, floor cooling is possible. For this reason, it is possible to actively cool the vicinity of a body height of the chicken, and efficiently create a comfortable space with less energy than cooling the entire poultry house 10 with an air conditioner.

In addition, the floor surface 11 of the poultry house 10 is brought to a predetermined temperature by circulating the mixed medium in which the second medium cooled by cold heat and the first medium heated by hot heat are mixed in the inside of the second pipe 33. According to such a configuration, it is possible to maintain the condition of the litter (bedding) and the air in the poultry house 10 in good condition. Further, by adjusting and supplying the mixed medium to the required temperature instead of conventional natural heat dissipation when it is intended to lower the temperature in order to freely control the temperature of the floor surface 11, it can follow a temperature change without delay even with a rapid temperature change in the external environment.

### Modified Example 1

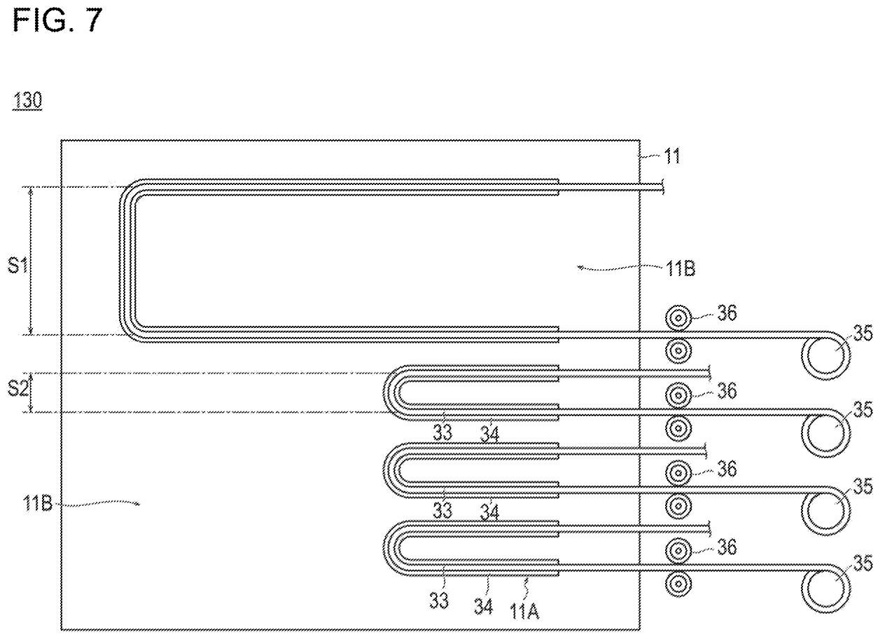

Next, a configuration of a poultry farming system according to Modified Example 1 will be described with reference to FIG. 7. FIG. 7 is a systematic diagram showing a portion of a heating unit 130 of a poultry farming system according to Modified Example 1.

In the embodiment described above, the positioning portion 34 positions the second pipe 33 such that the intervals S1 and S2 between the adjacent second pipes 33 are different from each other. However, as shown in FIG. 7, the positioning portion 34 may position the second pipe 33 such that the intervals S1 and S2 are variable and a lateral length of the second pipe 33 is partially reduced. At this time, as shown in FIG. 7, a warm place 11A and a cool place 11B are formed on the floor surface 11 of the poultry house 10, and the cool place 11B can be formed in a wider range.

### Modified Example 2

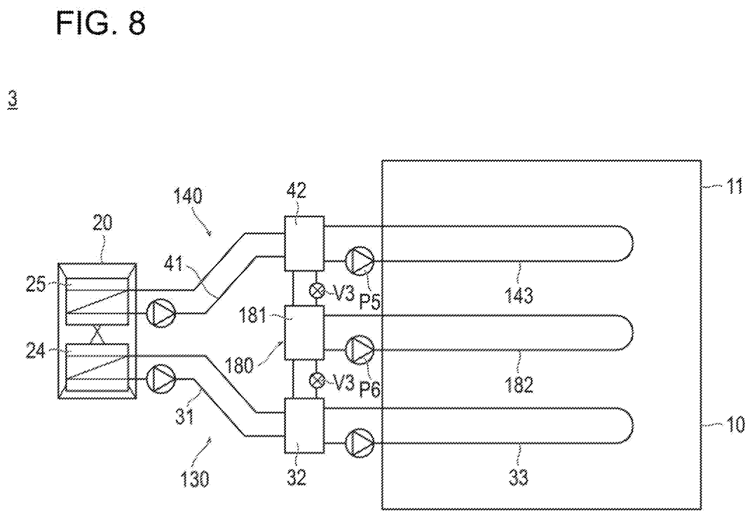

Next, a configuration of a poultry farming system 3 according to Modified Example 2 will be described with reference to FIG. 8. FIG. 8 is a schematic systematic diagram showing a poultry farming system 3 according to Modified Example 2.

As shown in FIG. 8, a poultry farming system 3 according to Modified Example 2 includes the poultry house 10, the heat pump 20, the heating unit 130, the cooling unit 140, the adjusting unit 50, the exhaust fan 60, the sterilizer 70, and a mixing unit 180. Since the configurations of the poultry house 10, the heat pump 20, the adjusting unit 50, the exhaust fan 60, and the sterilizer 70 are the same as those in the above-described embodiments, a description thereof will be omitted.

As shown in FIG. 8, the heating unit 130 includes the first pipe 31 for receiving hot heat from the hot heat exchanger 24, the heating tank 32 in which the first medium that has received the hot heat from the hot heat exchanger 24 is stored, and the second pipe 33 arranged under the floor of the poultry house 10.

As shown in FIG. 8, the cooling unit 140 includes the fourth pipe 41 for receiving cold heat from the cold heat exchanger 25, the cooling tank 42 in which the second medium that has received the cold heat from the cold heat exchanger 25 is stored, and a sixth pipe 143 arranged under the floor of the poultry house 10. Circulation of the second medium in the sixth pipe 143 is performed by a third cooling pump P5.

The mixing unit 180 mixes the first medium stored in the heating tank 32 and the second medium stored in the cooling tank 42 to produce a third medium. The mixing unit 180 includes a mixing tank 181 continuous with the heating tank 32 and the cooling tank 42, and a seventh pipe 182 arranged under the floor of the poultry house 10. Circulation of the third medium in the seventh pipe 182 is performed by a pump P6. The heating tank 32 and the mixing tank 181, and the cooling tank 42 and the mixing tank 181 are connected via a valve V3.

The amount of the first medium supplied from the heating tank 32 to the mixing tank 181 can be adjusted by an opening of the valve V3. In addition, the amount of the second medium supplied from the cooling tank 42 to the mixing tank 181 can be adjusted by the opening of the valve V3.

According to the poultry farming system 2 configured as described above, the temperature of the floor surface 11 can be increased in the order of a place where the second pipe 33 is arranged, a place where the seventh pipe 182 is arranged, and a place where the sixth pipe 143 is arranged. Therefore, it is possible for the chicken to move to a warm place or a cool place by itself.

Further, in Modified Example 2, the medium flowing through the second pipe 33, the seventh pipe 182, and the sixth pipe 143 has different temperatures, but for example, the temperatures of the medium flowing through the second pipe 33 and the seventh pipe 182 may be different, and the temperatures of the medium flowing through the seventh pipe 182 and the sixth pipe 143 may be the same.

### Modified Example 3

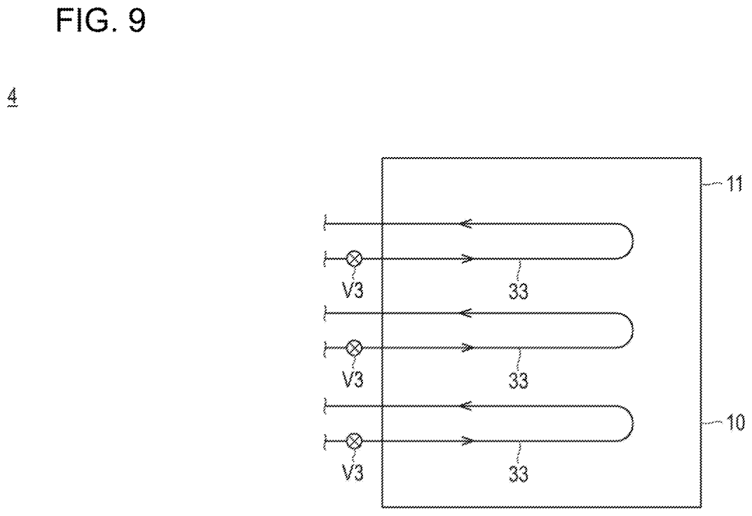

Next, a configuration of a poultry farming system 4 according to Modified Example 3 will be described with reference to FIG. 9. FIG. 9 is a schematic systematic diagram showing a portion of a poultry farming system 4 according to Modified Example 3.

As shown in FIG. 9, a poultry farming system 4 according to Modified Example 3 includes a plurality of (three in FIG. 9) second pipes 33, and an adjusting valve V7 provided in each of the plurality of second pipes 33 and capable of adjusting a flow rate of the first medium in the plurality of second pipes 33. In the poultry farming system 4 according to Modified Example 3, the heated first medium is circulated through the plurality of second pipes 33. According to the poultry farming system 4 configured as described above, by providing an appropriate difference between the second pipes 33 in the flow rate of the first medium flowing through the plurality of second pipes 33 by the adjusting valve V7, a temperature difference can be generated on the floor surface 11.

Note that the present invention is not limited to the above-described embodiments, and can be variously modified within the scope of the claims.

For example, in the embodiments described above, the present invention is applied to the poultry farming system for breeding the chickens as a livestock stall system, but may be applied to breeding pigs and the like.

In addition, in the embodiments described above, the positioning portion 34 positions the second pipe 33 such that a distance from the floor surface 11 was constant. However, the positioning portion 34 may position the second pipe 33 such that the distance from the floor surface 11 varies depending on the place. According to such a configuration, a temperature gradient can be generated on the floor surface 11 according to a depth from the floor surface 11. Therefore, the chicken can move to a place in a more favorable temperature environment.

In addition, in the embodiments described above, the heating unit 30 has the heating tank 32, and the cooling unit 40 has the cooling tank 42. However, the heating unit may not have the heating tank, and the cooling unit may not have the cooling tank. At this time, it is preferable that a radiator for exhausting the cold heat and the hot heat taken out of the heat pump is provided.

In addition, in the embodiments described above, in order to dehumidify the poultry house 10, the adjusting unit 50 turns off the supply of the first medium to the adjusting unit 50, and turns on the supply of the second medium to the adjusting unit 50. However, in order to dehumidify the poultry house 10, the supply of the first medium to the adjusting unit 50 may be turned on, and the supply of the second medium to the adjusting unit 50 may be turned on.

In addition, in the embodiments described above, the form of dehumidification by a so-called compressor system that dehumidifies by utilizing the condensation generated by cooling the air was described. However, the dehumidification may be performed by a so-called desiccant type that dehumidifies by adsorbing the moisture to a desiccant.

In addition, in the second embodiment described above, the three-way valve V4 was provided at the place where the first bypass 81 is connected to the second pipe 33, the three-way valve V5 was provided at the place where the second bypass 82 is connected to the second pipe 33, and the three-way valve V6 was provided at the place where the third bypass 83 is connected to the second pipe 33. However, the valve arranged at each place may be a two-way valve.

### REFERENCE SIGNS LIST

1, 2, 3, 4 Poultry farming system (livestock stall system)

10 Poultry house

11 Floor surface

20 Heat pump

31 First pipe

32 heating tank

33 Second pipe (pipe)

34 Positioning portion

35 Winding portion

36 Cleaning portion

S1, S2 Interval between first pipes

1. A livestock stall system comprising:
a livestock stall in which livestock is bred; and
a pipe that is arranged to pass under a floor of the livestock stall and adjusts a temperature of a floor surface of the livestock stall by a medium circulating through an inside of the pipe.

2. The livestock stall system according to claim 1, further comprising a heat pump capable of simultaneously taking out hot heat and cold heat,
wherein the floor surface of the livestock stall is cooled by circulating the medium cooled by the cold heat in the inside of the pipe.

3. The livestock stall system according to claim 2, wherein the floor surface of the livestock stall is brought to a predetermined temperature by circulating a mixed medium in which a cooling medium cooled by the cold heat and a heating medium heated by the hot heat are mixed in the inside of the pipe.

4. The livestock stall system according to claim 1, wherein the pipe is arranged such that a temperature difference occurs on the floor surface.

5. The livestock stall system according to claim 4, wherein the pipe is arranged such that intervals between adjacent pipes are different from each other.

6. The livestock stall system according to claim 1,
wherein a plurality of pipes are provided, and
the temperatures of the medium circulating through at least two pipes are different from each other.

7. The livestock stall system according to claim 1,
wherein a plurality of pipes are provided, and
an adjusting valve provided on each of the plurality of pipes and capable of adjusting a flow rate of the medium in the plurality of pipes is further included.
